(19) United States
(12) Patent Application Publication
(10) Pub. No.: US 2010/0104856 A1
(43) Pub. Date: Apr. 29, 2010

(54) BOEHMITE-FILLED POLYPROPYLENE RESIN COMPOSITION AND MOLDED ARTICLE COMPRISING THE SAME

(75) Inventors: Kenji Ikeda, Chiba (JP); Yusuke Kawamura, Ehime (JP); Katsuhisa Kitano, Rabigh (SA)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: SUMITOMO CHEMICAL COMPANY, LIMITED, Chuo-ku, Tokyo (JP)

(21) Appl. No.: 12/531,555

(22) PCT Filed: Mar. 24, 2009
(86) PCT No.: PCT/JP2008/056253

§ 371 Date: Sep. 16, 2009

(30) Foreign Application Priority Data
Mar. 23, 2007 (JP) 2007-076408

(51) Int. Cl. C08K 3/10; B32B 5/16

(52) U.S. Cl. 428/323; 524/437

(57) ABSTRACT

There is provided a polypropylene resin composition comprising 50 to 99% by weight of a resin (I) and 1 to 50% by weight of boehmite (C) having a BET specific surface area of 20 to 80 m²/g, c-length of 30 to 300 nm, and a ratio of a-axis length to b-axis length of 5 or more, the resin (I) containing 50 to 75% by weight of a polypropylene resin (A), which contains a propylene homopolymer and/or a propylene-ethylene random copolymer containing 1.0% by weight or less of ethylene units, and 25 to 50% by weight of an elastomer (B), provided that the total of the resin (I) and boehmite (C) is 100% by weight, and the total of the polypropylene resin (A) and the elastomer (B) is 100% by weight.

### TECHNICAL FIELD

The present invention relates to a boehmite-filled polypropylene resin composition and a molded article comprising the resin composition. In more detail, the present invention relates to a boehmite-filled polypropylene resin composition useful as a material for a molded article, which has an excellent balance between its impact resistance and rigidity.

### BACKGROUND ART

As a polypropylene resin material having an excellent balance between its impact resistance and rigidity, there is known heretofore a polypropylene resin composition containing an inorganic filler and an elastomer.

For example, JP 2003-286372A discloses that a molded article excellent in its rigidity and surface hardness can be obtained from a polypropylene resin composition, which composition is obtained by blending aluminum hydroxide having a maximum diameter of 20 μm or smaller. Also, JP 2005-126287A discloses that a molded article excellent in its surface hardness can be obtained from a polypropylene resin composition, which composition contains boehmite having an average major axis of 100 to 900 nm.

The above polypropylene resin compositions have been required to be further improved in a balance between their impact resistance and rigidity.

### DISCLOSURE OF INVENTION

An object of the present invention is to provide a polypropylene resin composition useful as a material for a molded article, which has an excellent balance between its impact resistance and rigidity.

The present invention is a polypropylene resin composition comprising:

50 to 99% by weight of a resin (I); and

1 to 50% by weight of boehmite (C) having a BET specific surface area of 20 to 80 m²/g, c-length of 30 to 300 nm, and a ratio of a-axis length to b-axis length of 5 or more; the resin (I) containing:

50 to 75% by weight of a polypropylene resin (A), which contains a propylene homopolymer and/or a propylene-ethylene random copolymer containing 1.0% by weight or less of ethylene units; and

25 to 50% by weight of an elastomer (B); provided that the total of the resin (I) and boehmite (C) is 100% by weight, and the total of the polypropylene resin (A) and the elastomer (B) is 100% by weight.

### BRIEF DESCRIPTION OF THE DRAWINGS

FIG. 1 shows a-axis, b-axis and c-axis of boehmite particles.

### BEST MODE FOR CARRYING OUT THE INVENTION

The polypropylene resin (A) used in the present invention contains a propylene homopolymer and/or a propylene-ethylene random copolymer containing 1.0% by weight or less of ethylene units, which content is measured according to an IR method or an NMR method disclosed in “New Edition: KOBUNSHI ANALYSIS HANDBOOK” edited by The Chemical Society of Japan, Society of Polymer Analysis and Research, published by Kinokuniya Co., Ltd. (1995).

From a viewpoint of rigidity and heat resistance, the polypropylene resin (A) is preferably a propylene homopolymer, or a propylene-ethylene random copolymer containing 0.5% by weight or less of ethylene units, or a mixture of a propylene homopolymer with a propylene-ethylene random copolymer containing 0.5% by weight or less of ethylene units; more preferably a propylene homopolymer, or a propylene-ethylene random copolymer containing 0.3% by weight or less of ethylene units, or a mixture of a propylene homopolymer with a propylene-ethylene random copolymer containing 0.3% by weight or less of ethylene units; and most preferably a propylene homopolymer.

The polypropylene resin (A) is produced according to a method such as a solution polymerization method, a slurry polymerization method, a bulk polymerization method and a gas phase polymerization method. Those polymerization methods are used alone or in a combination of two or more thereof. Examples of a production method of the polypropylene resin (A) are polymerization methods disclosed in documents such as “Shin Polymer Seizo Process” (edited by Yasuji SAEKI, published by Kogyo Chosakai Publishing, Inc. (1994)), JP 4-323207A and JP 61-287917A.

Examples of a catalyst used for producing the polypropylene resin (A) are a multiple site catalyst and a single site catalyst. The multiple site catalyst is preferably a catalyst obtained using a solid catalyst component containing a titanium atom, a magnesium atom and a halogen atom. The single site catalyst is preferably a metallocene catalyst.

Examples of the elastomer (B) used in the present invention are an olefin elastomer, a styrene elastomer, a polyester elastomer, a polyurethane elastomer, and a PVC elastomer. Among them, preferred is an olefin elastomer or a styrene elastomer, and more preferred is an olefin elastomer.

The olefin elastomer is a polymer obtained by polymerizing ethylene with an α-olefin having 3 to 20 carbon atoms. The olefin elastomer contains preferably 10 to 85% by weight of ethylene units. Examples of the α-olefin having 3 to 20 carbon atoms are propylene, 1-butene, isobutene, 1-pentene, 2-methyl-1-butene, 3-methyl-1-butene, 1-hexene, 2-methyl-1-pentene, 3-methyl-1-pentene, 4-methyl-1-pentene, 1-octene, 1-nonene, 1-decene, 1-undecene, and 1-dodecene. Among them, preferred is propylene, 1-butene, 1-hexene or 1-octene.

Examples of the olefin elastomer are an ethylene-propylene copolymer elastomer, an ethylene-butene-1 copolymer elastomer, an ethylene-hexene-1 copolymer elastomer, and an ethylene-octene-1 copolymer elastomer. These olefin elastomers are used alone or in combination of two or more thereof. Among them, preferred is an ethylene-butene-1 copolymer elastomer or an ethylene-octene-1 copolymer elastomer.

The olefin elastomer has a density of preferably 0.85 to 0.885 g/cm³, more preferably 0.85 to 0.88 g/cm³, and further preferably 0.855 to 0.875 g/cm³, from a viewpoint of its dispersibility in the polypropylene resin (A), and impact strength of the obtained resin composition at room temperature or low temperature. The olefin elastomer has a melt flow rate (MFR) at 190° C. of preferably 0.1 to 30 g/10 minutes, and more preferably 0.5 to 20 g/10 minutes, from a viewpoint of impact strength of the obtained resin composition.

The olefin elastomer is produced, for example, using a polymerization catalyst known in the art, according to a polymerization method known in the art. Examples of the polymerization catalyst known in the art are a Ziegler·Natta catalyst system comprising a vanadium compound, an organoaluminum compound and a halogenated ester compound, and a so-called metallocene catalyst system combining a metallocene compound with an alumoxane or a boron compound, wherein the metallocene compound contains a titanium atom, a zirconium atom or a hafnium atom, to which one or more kinds of cyclopentadiene-containing anionic groups coordinate.

Examples of the polymerization method applicable to the present invention are a method of copolymerizing ethylene with an α-olefin in an inert organic solvent such as hydrocarbon compounds, and a method of copolymerizing ethylene with an α-olefin using no solvent.

The olefin elastomer may be a commercially-available elastomer having a trade name such as DYNARON manufactured by JSR Corporation; MILASTOMER and TAFMER manufactured by Mitsui Chemicals, Inc.; THERMORUN and SPX manufactured by Mitsubishi Chemical Corporation; NEWCON manufactured by Chisso Corporation; MNCS manufactured by Bridgestone Corporation; HiFax and AdFlex manufactured by Montel JPO Corporation; MIRAPRENE manufactured by Mitsubishi Chemical MKV Corporation; and SUMITOMO TPE, ESPRENE EPDM and ESPRENE SPO manufactured by Sumitomo Chemical Co., Ltd.

Examples of the styrene elastomer are a block copolymer containing polymer blocks of a vinyl aromatic compound and conjugated diene polymer blocks, and a block copolymer obtained by hydrogenating double bonds contained in conjugated diene polymer blocks of the above block copolymer. Among them, preferred is a block copolymer obtained by hydrogenating 80% or more of the double bonds contained therein, and more preferred is a block copolymer obtained by hydrogenating 85% or more of the double bonds contained therein.

The elastomer containing polymer blocks of a vinyl aromatic compound has a molecular weight distribution of preferably 2.5 or less and more preferably 2.3 or less, in terms of a ratio (Mw/Mn), Mw and Mn being a weight average molecular weight and a number average molecular weight, respectively, measured according to gel permeation chromatography (GPC).

The styrene elastomer contains polymerization units of the vinyl aromatic compound in an amount of preferably 10 to 20% by weight, and more preferably 12 to 19% by weight.

The styrene elastomer has a melt flow rate (MFR, A.S.T.M. D1238 at 230° C.) of preferably 1 to 15 g/10 minutes, and more preferably 2 to 13 g/10 minutes.

Examples of the styrene elastomer are block copolymers such as a styrene-ethylene-butene-styrene rubber (SEBS), a styrene-ethylene-propylene-styrene rubber (SEPS), a styrene-butadiene rubber (SBR), a styrene-butadiene-styrene rubber (SBS), and a styrene-isoprene-styrene rubber (SIS); and block copolymers obtained by hydrogenating rubber components contained in the above respective block copolymers.

Also, rubbers such as an ethylene-propylene-non-conjugated diene rubber (EPDM) can be used suitably, which rubbers are obtained by reacting an olefin copolymer rubber with a vinyl aromatic compound such as styrene. Further, there may be used a combination of two or more kinds of elastomers containing polymerization units of a vinyl aromatic compound.

An example of a production method of the styrene elastomer is a method comprising the step of connecting a vinyl aromatic compound to an olefin copolymer rubber or a conjugated diene rubber.

The styrene elastomer may be a commercially-available styrene elastomer having a trade name such as KRATON manufactured by Shell Chemical; TUFPRENE, ASAPRENE and TUFTEC manufactured by Asahi Kasei Corporation; JSR TR, JSR SIS and DYNARON manufactured by JSR Corporation; HYBRAR and SEPTON manufactured by Kuraray Co., Ltd.; RABALON manufactured by Mitsubishi Chemical Corporation; and SUMITOMO TPE-SB and SUMITOMO SBR manufactured by Sumitomo Chemical Co., Ltd.

Boehmite (C) is a powder having a BET specific surface area of 20 to 80 m²/g, c-axis length of 30 to 300 nm, and a ratio (a-axis length to b-axis length) of 5 or more, and is represented by the chemical formula of AlOOH. A crystal structure of boehmite (C) (AlOOH) can be identified according to a method disclosed in JP 2006-62905A, comprising the steps of consolidating a sample on a non-reflecting glass plate; then measuring a diffraction pattern of the sample powder with an X-ray diffractometer, RINT 2000, manufactured by Rigaku Corporation; and comparing the diffraction pattern with JCPDS (Joint Committee on Diffraction Standards) 21-1307.

Boehmite (C) in the present invention may contain a small amount of powders having a crystal structure of gibbsite or bayerite, both being represented by the chemical formula of Al(OH)₃ or Al₂O₃·3H₂O. In this case, a ratio of peak height of a main peak, which indicates a gibbsite or bayerite structure in a powder XRD spectrum, to peak height of a main peak, which indicates a boehmite structure therein, is usually 5% or less. Also, boehmite may contain amorphous aluminum hydroxide.

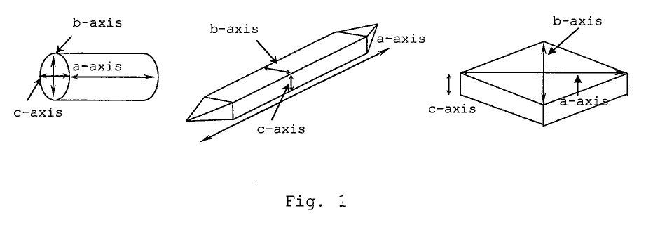

The ratio (a-axis length to b-axis length) of boehmite (C) is 5 or more, preferably 5 to 50, more preferably 5 to 30, and further preferably 10 to 30, from a viewpoint of mechanical strength such as rigidity of molded articles, and moldability of the boehmite-filled polypropylene resin composition. The ratio (a-axis length to b-axis length) of boehmite (C) in the present invention is a ratio of a-axis directional length to b-axis directional length, wherein the a-axis is determined according to a method comprising the steps of taking a photograph of boehmite (C) using an electron or optical microscope, then selecting a particle of boehmite (C) non-overlapping with other particles in the photograph, and assigning the longest axis in the selected particle to the a-axis, and an axis at right angle to the a-axis is assigned to the b-axis. FIG. 1 exemplifies shapes of particles of boehmite (C), and shows an a-axis, a b-axis and a c-axis of those particles. The c-axis is at right angle to each of the a-axis and the b-axis. The a-axis, the b-axis and the c-axis have a relation in their axis length: a-axis length>b-axis length≧c-axis length. Each of the a-axis length and the b-axis length is calculated as a number average value of measured values of ten samples randomly selected from a scanning electron micrograph. Also, the b-axis length is divided into suitable size-carrying classes, thereby making histogram representation. When the histogram has two peaks, there are taken the steps of dividing into two groups at the center between those two peaks, then calculating number average values of axis length in respective groups, and further dividing into a larger number average value (b-axis length) and a smaller number average value (c-axis length).

From a viewpoint of mechanical strength such as rigidity of molded articles, and moldability of the boehmite-filled polypropylene resin composition, boehmite (C) in the present invention has an a-axis length of preferably 0.3 μm to 10 μm, more preferably 0.5 μm to 5 μm, and further preferably 1 to 4 μm, and has a c-axis length of preferably 0.03 μm to 0.3 μm, and more preferably 0.05 μm to 0.3 μm.

A shooting procedure of photographs with use of an electron microscope comprises the following steps of dispersing boehmite particles in a solvent, thereby obtaining a dispersion liquid having a solid content concentration of 1% or less, the above solvent being suitably selected from solvents easily dispersing boehmite particles, such as water and alcohols; reducing aggregation among the particles by a method such as an ultrasonic irradiation method (under agitation), thereby obtaining a dispersion liquid; applying the dispersion liquid on a specimen support, and then drying, thereby obtaining a measurement sample; shooting electron microscope images with use of the measurement sample; suitably selecting a particle of boehmite (AlOOH) non-overlapping with other particles; and measuring a-axis length, b-axis length and c-axis length of boehmite according to the above-mentioned method.

Boehmite (C) has a BET specific surface area of 20 to 80 m²/g, preferably 30 to 80 m²/g, and particularly preferably 50 to 80 m²/g, from a viewpoint of mechanical strength such as rigidity of molded articles.

Boehmite (C) can be obtained according to, for example, a method comprising the steps of adding a metal acetate together with aluminum hydroxide to water, and hydrothermally treating, as disclosed in JP 2000-239014A; and a method comprising the step of hydrothermally treating boehmite-typed aluminum hydroxide and gibbsite-typed aluminum hydroxide in the presence of magnesium, as disclosed in JP 2006-160541A. Also, boehmite (C) can be obtained according to a method comprising the steps of adding a metal acetate together with aluminum hydroxide to water, thereby obtaining an aqueous solution, then acidizing the aqueous solution by a carboxylic acid or the like, and hydrothermally treating.

From a viewpoint of rigidity and a heat resistance of molded articles, the polypropylene resin composition of the present invention contains preferably aromatic carboxylic acids, and further preferably compounds having a condensed aromatic ring and a carboxyl group. The condensed aromatic ring may contain a hetero atom. A compound having a condensed aromatic ring and a carboxyl group is referred to as R—COOH. Examples of compounds having a structure R—H, whose R corresponds to the above-mentioned R, are indene, naphthalene, fluorene, phenanthrene, anthracene, pyrene, chrysene, naphthacene, benzofuran, isobenzofuran, benzo[b]thiophene, indole, isoindole, benzoxazole, quinoline, isoquinoline, cinnoline, phthalazine, quinazoline, quinoxaline, dibenzofuran, carbazole, acridine, phenanthridine, 1,10-phenanthridine, phenazine, phenoxazine, thianthren, and indolizine. In the present invention, aromatic carboxylic acids may be used in combination of two or more kinds of them.

Examples of the aromatic carboxylic acids are p-tert-butylbenzoic acid, benzoic acid, 1-naphthoic acid, 2-naphthoic acid, 4-methyl-1-naphthoic acid, 4-hydroxy-1-naphthoic acid, 6-hydroxy-2-naphthoic acid, naphthalic acid, 1-anthracene carboxylic acid, 2-anthracene carboxylic acid, and 9-anthracene carboxylic acid. Among them, preferred is p-tert-butylbenzoic acid, benzoic acid, 1-naphthoic acid, 2-naphthoic acid, 1-anthracene carboxylic acid, 2-anthracene carboxylic acid, or 9-anthracene carboxylic acid; more preferred is 1-naphthoic acid, 2-naphthoic acid, 1-anthracene carboxylic acid, 2-anthracene carboxylic acid, or 9-anthracene carboxylic acid; and further preferred is 1-naphthoic acid or 2-naphthoic acid.

When using an aromatic carboxylic acid, the aromatic carboxylic acid is blended in an amount of preferably 0.01 to 10 parts by weight, more preferably 0.05 to 5 parts by weight, and further preferably 0.1 to 3 parts by weight, the total of the polypropylene resin (A), the elastomer (B) and boehmite (C) being 100 parts by weight, from a viewpoint of mechanical strength such as rigidity, and moldability.

In the present invention, the component (A) is contained in an amount of 50 to 75% by weight, preferably 50 to 73% by weight, and more preferably 50 to 70% by weight, and the component (B) is contained in an amount of 25 to 50% by weight, preferably 27 to 50% by weight, and more preferably 30 to 50% by weight, the total content of the components (A) and (B) being 100% by weight, from a viewpoint of mechanical strength such as rigidity and impact strength of molded articles, and ease of production of the composition, and moldability of the composition.

From a viewpoint of mechanical strength such as rigidity of molded articles, and ease of production of the composition, and moldability of the composition, the resin (I) is contained in an amount of preferably 50 to 95% by weight, more preferably 60 to 95% by weight, further preferably 70 to 95% by weight, and still further preferably 80 to 95% by weight, and the component (C) is contained in an amount of preferably 5 to 50% by weight, more preferably 5 to 40% by weight, further preferably 5 to 30% by weight, and still further preferably 5 to 20% by weight.

The resin composition of the present invention is not particularly limited in its production method. For example, the resin composition of the present invention can be produced according to a process comprising the steps of mixing all the components of the polypropylene resin composition of the present invention, thereby obtaining a homogeneous mixture, and then melt-kneading the mixture.

The above homogeneous mixture is obtained, for example, according to a method of mixing by a Henschel mixer, a ribbon blender, a blender or the like. The above homogeneous mixture is melt-kneaded, for example, by a Banbury mixer, PLASTMIL, BRABENDER PLASTOGRAPH, a single or twin screw extruder, or the like.

Examples of a method of mixing the components (A) and (B) with each other are a melt-kneading method, a solution blending method, and a method of mixing in a polymerization process. The component (B) mixed in a polymerization process is referred to as the component (B1), and the component (B) mixed according to a melt-kneading method or a solution blending method is referred to as the component (B2).

An example of a method of mixing the components (A) and (B) in a polymerization process is a method comprising the steps of producing the component (A) in a first process, and producing the component (B1) in a second process. A method of mixing the components (A) and (B1) in a polymerization process can use a catalyst known in the art, such as a Ziegler·Natta catalyst and a metallocene catalyst. There can also be utilized a polymerization method known in the art, such as a slurry polymerization method, a bulk polymerization method, and a gas-phase polymerization method, and those polymerization methods may be combined mutually.

A method of mixing the components (A) and (B1) in a polymerization process is disclosed in patent documents such as JP 5-194685A, JP 6-93061A, JP 6-199928A and JP 2005-290101A.

Examples of a method of mixing the components (A) and (B2) are the above-mentioned melt-kneading method and a solution blending method known in the art.

A method of mixing the components (A) and (B) may be a combined method of a melt-kneading method, a solution blending method, and a method of mixing in a polymerization process, known in the art. For example, the components (A) and (B1) are mixed with each other in a polymerization process, and then the resultant mixture is further melt-kneaded with the component (B2). In this case, the component (B1) mixed in a polymerization process may be the same as the component (B2) mixed according to a melt-kneading method.

The polypropylene resin composition of the present invention may contain various kinds of additives, depending on the intended use, for example, additives for modification such as nucleating agents, antioxidants, weather resistance agents, light stabilizers, ultraviolet absorbers, antistatic agents, slipping agents, antiblocking agents, antifog additives, pigments, heat stabilizers, neutralizing agents, dispersing agents, plasticizers, and flame retardants; and coloring agents such as pigments and dyes. Also, inorganic particles known in the art may be contained as fillers, for example, particulate fillers such as carbon black, titanium oxide, talc, calcium carbonate, mica and clay; short-fiber fillers such as wollastonite; and whiskers such as potassium titanate. Further, modifiers known in the art may be contained, for example, rubbers and modified resins such as polypropylenes modified by maleic anhydride. Those additives, fillers or modifiers may be added to the polypropylene resin composition of the present invention during the production of the resin composition, or may be added thereto during the production of molded articles from the resin composition.

The polypropylene resin composition of the present invention can be molded according to a suitable molding method, thereby obtaining molded articles. Examples of the molding method are an injection molding method, an injection compression molding method, a gas assist molding method, and an extrusion molding method.

Molded articles obtained from the polypropylene resin composition of the present invention are used, for example, as automotive plastic parts, and examples thereof are exterior parts requiring mechanical strength, endurance and good appearance, and interior parts requiring rigidity at high temperature.

Examples of the exterior parts are fender, over fender, grill guard, cowl louver, wheel cap, wheel cover, side protector, side moulding, side lower skirt, front grill, side step, roof rail, rear spoiler, bumper, tail gate, sunroof deflector, roof rail, door mirror stay, door mirror cover, rear quarter panel, side cover, cowl top garnish, and front grill. Examples of the interior parts are instrument panel, trim, tailgate, headliner, pillar, door lining, seat side cover, center console, register blade, washer lever, wind regulator, knob of wind regulator handle, passing light lever, sun visor bracket, sun visor arm, accelerator pedal, shift lever bracket, steering rock bracket, key cylinder, door inner handle, door handle cowl, indoor mirror bracket and air conditioner switch.

### EXAMPLE

The present invention is explained with the following Examples, which are merely exemplified embodiments, and do not limit the present invention.

Samples for evaluation used in Example or Comparative Example were produced according to the following methods.
(1) Production Method of Samples for Evaluation

Samples for evaluation were molded under the following conditions, using an injection molding machine, J28SC, manufactured by The Japan Steel Works, Ltd.:

mold clamping force: 270 kN,

cylinder temperature: 200° C.,

mold temperature: 50° C., and

back pressure: 0.5 MPa.

Tables 1 to 4 show compositions of samples used in Examples and Comparative Examples.

Next, the followings are evaluation methods used in Examples and Comparative Examples.
(1) Flexural Modulus (Unit: MPa)

It was measured according to A.S.T.M. D790 under the following conditions:

measurement temperature: 23° C.;

sample shape: 12.7×80 mm (thickness of 4.0 mm)

span: 64 mm; and

tensile speed: 2 mm/minute.
(2) IZOD Impact Strength (Unit: kJ/m²)

It was measured according to A.S.T.M. D256 under the following conditions:

measurement temperature: 23° C.; and

sample shape: 12.7×64 mm (thickness of 4.0 mm); wherein molded samples were notched.
(3) MFR (Unit: g/10 Minutes)

It was measured according to A.S.T.M. D1238 under the following conditions:

measurement temperature: 230° C.; and

load: 21.2 N.

### Preparation of Boehmite

### Reference Example 1

There were mixed 100 parts by weight of aluminum hydroxide having a BET specific surface area of 25 m²/g, a central particle diameter of 0.5 μm and a gibbsite structure, 219 parts by weight of magnesium acetate tetrahydrate [CH₃COOMg·4H₂O], and 2,100 parts by weight of pure water, thereby obtaining a slurry. Acetic acid [CH₃COOH] was added to the slurry, thereby adjusting its hydrogen-ion concentration to pH of 5.0. The slurry was put in an autoclave, and was heated up to 200° C. from room temperature [about 23° C.] at a rate of temperature increase of 100° C./hour, and was maintained at 200° C. for 4 hours, thereby reacting hydrothermally. The reaction mixture was cooled, and was filtered, thereby obtaining the resultant solid. The solid was washed with water until its filtrate showed an electrical conductivity of 100 μS/cm or less. Pure water was added to the washed solid, thereby obtaining its slurry having a solid concentration of 5% by weight. The slurry was filtered with a SUS-made sieve having an opening of 45 μm to remove coarse particles. The obtained slurry was spray-dried with a spray dryer, type MOBILE MINOR, manufactured by Niro Japan Co., Ltd., at an outlet temperature of 120° C., and then was pulverized with ROTOR SPEED MILL, P-14, manufactured by Fritsch Japan Co., Ltd., thereby obtaining powder (C-1). This powder was confirmed to be boehmite (AlOOH) based on its powder XRD pattern. This boehmite (C-1) had a BET specific surface area of 66 m²/g, an a-axis length of 2,520 nm, a b-axis length of 102 nm, a c-axis length of 102 nm, and a ratio of the a-axis length to the b-axis length (a-axis length/b-axis length) of 25. The BET specific surface area was measured according to a nitrogen adsorption method. Each of the a-axis length, the b-axis length and the c-axis length was calculated as a number average value of measured values of ten samples randomly selected from a scanning electron micrograph. The ratio of the a-axis length to the b-axis length (a-axis length/b-axis length) was calculated as a number average value of respective values obtained by dividing each a-axis length by each b-axis length of the above ten samples.

### Reference Example 2

There were mixed 100 parts by weight of gibbsite type aluminum hydroxide having a BET specific surface area of 25 m²/g and a central particle diameter of 0.5 μm, 218 parts by weight of magnesium acetate tetrahydrate, and 2,100 parts by weight of pure water, thereby obtaining a slurry. On the other hand, an aluminum alkoxide was hydrolyzed, thereby preparing boehmite type aluminum hydroxide having a BET specific surface area of 307 m²/g. There was added 50 parts by weight of a slurry [solid concentration of 10% by weight] obtained by dispersing the above-prepared boehmite type aluminum hydroxide in 0.1 N nitric acid aqueous solution [nitric acid concentration of 0.1 mol/L], to the above-obtained slurry, and the resultant mixture had a hydrogen-ion concentration of pH of 7.0. Then, the mixture was put in an autoclave, and was heated up to 200° C. from room temperature [20° C.] at a rate of temperature increase of 100° C./hour, and was maintained at 200° C. for 4 hours, thereby reacting hydrothermally. The reaction mixture was cooled, and was filtered, thereby obtaining the resultant solid. The solid was washed with water until its filtrate showed an electrical conductivity of 100 μS/cm or less. Pure water was added to the washed solid, thereby obtaining its slurry having a solid concentration of 5% by weight. The slurry was filtered with a SUS-made sieve having an opening of 45 μm to remove coarse particles. The obtained slurry was spray-dried with a spray dryer, type MOBILE MINOR, manufactured by Niro Japan Co., Ltd., at an outlet temperature of 120° C., and then was pulverized with ROTOR SPEED MILL, P-14, manufactured by Fritsch Japan Co., Ltd., thereby obtaining powder (C-2).

This powder was confirmed to be boehmite (AlOOH) based on its powder XRD pattern. This boehmite (C-2) had a BET specific surface area of 126 m²/g, an a-axis length of 103 nm, a b-axis length of 7 nm, a c-axis length of 7 nm, and a ratio of the a-axis length to the b-axis length (a-axis length/b-axis length) of 15. The BET specific surface area was measured according to a nitrogen adsorption method. Each of the a-axis length, the b-axis length and the c-axis length was calculated as a number average value of measured values of ten samples randomly selected from a scanning electron micrograph. The ratio of the a-axis length to the b-axis length (a-axis length/b-axis length) was calculated as a number average value of respective values obtained by dividing each a-axis length by each b-axis length of the above ten samples.

### Production of Polyolefin Resin Composition and Evaluation Thereof

### Example 1

A propylene block copolymer (F-1), an ethylene-octene copolymer elastomer (B2-1), ENGAGE 8200, manufactured by DuPont Dow Elastomers K. K., and boehmite (C-1) obtained in Reference Example 1 were mixed with one another in a compounding ratio described in Table 1. There were added to the resultant mixture, 0.05 part by weight of calcium stearate manufactured by NOF Corporation, 0.1 part by weight of IRGANOX 1010 manufactured by Ciba Specialty Chemicals K. K., and 0.1 part by weight of IRGAFOS 168 manufactured by Ciba Specialty Chemicals K. K., the total of the components (F-1), (B2-1) and (C-1) being 100 parts by weight. The mixture was mixed homogeneously. The obtained mixture was melt-kneaded at a predetermined temperature of 180° C. and at a screw rotation speed of 500 rpm, using a double screw-kneading extruder, KZW15-45MG, manufactured by Technovel Corporation, the two screws rotating in the same direction and having a size of 15 mm×45 L/D, thereby obtaining pellets, whose MFR is shown in Table 1. The pellets were injection molded with a molding machine, J28SC, manufacture by The Japan Steel Works, Ltd., thereby obtaining a molded article. Table 1 shows flexural modulus and heat distortion temperature of the molded article.

The used propylene block copolymer (F-1) was produced according to a method disclosed in Example of JP 2006-083251A. The propylene block copolymer (F-1) had an MFR of 49 g/10 minutes, and contained 87% by weight of a propylene homopolymer portion (A-1), and 13% by weight of a propylene-ethylene random copolymer portion (elastomer portion) (B1-1).

### Example 2

Example 1 was repeated except that the compounding ratio between the propylene block copolymer (F-1) and the ethylene-octene copolymer elastomer (B2-1) was changed, as described in Table 1.

### Example 3

Example 1 was repeated except that the compounding ratio between the propylene block copolymer (F-1) and the ethylene-octene copolymer elastomer (B2-1) was changed, as described in Table 1.

### Example 4

Example 1 was repeated except that the compounding ratio among the propylene block copolymer (F-1), the ethylene-octene copolymer elastomer (B2-1), and the boehmite (C-1) was changed, as described in Table 1.

### Example 5

Example 1 was repeated except that the compounding ratio among the propylene block copolymer (F-1), the ethylene-octene copolymer elastomer (B2-1), and the boehmite (C-1) was changed, as described in Table 1.

### Example 6

Example 3 was repeated except that 1.0 part of 2-naphthoic acid (D-1) manufactured by Tokyo Chemical Industry Co., Ltd. was added, as described in Table 2.

### Example 7

Example 4 was repeated except that 0.5 part of 2-naphthoic acid (D-1) manufactured by Tokyo Chemical Industry Co., Ltd. was added, as described in Table 2.

### Example 8

Example 4 was repeated except that 1.0 part of 2-naphthoic acid (D-1) manufactured by Tokyo Chemical Industry Co., Ltd. was added, as described in Table 2.

### Comparative Example 1

Example 1 was repeated except that boehmite (C-1) was changed to talc (E-1), MWHST, manufactured by HAYASHI KASEI Co., Ltd., which was mixed with the propylene block copolymer (F-1) and the ethylene-octene copolymer elastomer (B2-1) in a compounding ratio described in Table 3.

### Comparative Example 2

Comparative Example 1 was repeated except that the compounding ratio of the propylene block copolymer (F-1) to the ethylene-octene copolymer elastomer (B2-1) was changed as described in Table 3.

### Comparative Example 3

Comparative Example 1 was repeated except that boehmite (C-1) was changed to fibrous magnesium sulfate (E-2), MOS-HIGE A, manufactured by Ube Material Industries, which was mixed with the propylene block copolymer (F-1) and the ethylene-octene copolymer elastomer (B2-1) in a compounding ratio described in Table 3.

### Comparative Example 4

Comparative Example 1 was repeated except that the compounding ratio of the propylene block copolymer (F-1) to the ethylene-octene copolymer elastomer (B2-1) was changed as described in Table 3.

### Comparative Example 5

Comparative Example 1 was repeated except that the compounding ratio among the propylene block copolymer (F-1), fibrous magnesium sulfate (E-2), and the ethylene-octene copolymer elastomer (B2-1) was changed as described in Table 4.

### Comparative Example 6

Example 1 was repeated except that boehmite (C-1) was not used, and the propylene block copolymer (F-1) and the ethylene-octene copolymer elastomer (B2-1) were mixed with each other in a compounding ratio described in Table 4.

### Comparative Example 7

Example 1 was repeated except that boehmite (C-1) was changed to boehmite (C-2), which was mixed with the propylene block copolymer (F-1) and the ethylene-octene copolymer elastomer (B2-1) in a compounding ratio described in Table 4.

TABLE 1

| | Example | | | | |
|---|---|---|---|---|---|
| Compounding ratio (part by weight) | 1 | 2 | 3 | 4 | 5 |
| (B2) Elastomer | | | | | |
| Kind | B2-1 | B2-1 | B2-1 | B2-1 | B2-1 |
| Compounding ratio (part by weight) | 19 | 21 | 22 | 21 | 19 |
| (C) Boehmite | | | | | |
| Kind | C-1 | C-1 | C-1 | C-1 | C-1 |
| Compounding ratio (part by weight) | 10 | 10 | 10 | 12 | 20 |
| (D) Aromatic carboxylic acid | | | | | |
| Kind | — | — | — | — | — |
| Compounding ratio (part by weight) | — | — | — | — | — |
| (E) Other | | | | | |
| Kind | — | — | — | — | — |
| Compounding ratio (part by weight) | — | — | — | — | — |
| (F) Propylene block copolymer | | | | | |
| Kind | F-1 | F-1 | F-1 | F-1 | F-1 |
| Compounding ratio (part by weight) | 71 | 69 | 68 | 67 | 61 |
| Composition | | | | | |
| (Based on components (A) + (B) + (C)) | | | | | |
| Component (A) (wt %) | 62 | 60 | 59 | 58 | 53 |
| Component (B) (wt %) | 28 | 30 | 31 | 30 | 27 |
| Component (C) (wt %) | 10 | 10 | 10 | 12 | 20 |
| Component (E) (wt %) | — | — | — | — | — |
| Component (B1) (wt %) | 9 | 9 | 9 | 9 | 8 |
| Component (B2) (wt %) | 19 | 21 | 22 | 21 | 19 |
| Composition | | | | | |
| (Based on components (A) + (B)) | | | | | |
| Component (B) (wt %) | 31 | 33 | 34 | 34 | 34 |
| Property | | | | | |
| Flexural modulus (MPa) | 1,730 | 1,660 | 1,580 | 1,780 | 2,250 |
| IZOD impact strength (kJ/m²) | 17 | 24 | 38 | 33 | 21 |
| MFR (g/10 minutes) | 22 | 17 | 20 | 17 | 2 |

TABLE 2

| | Example | | |
|---|---|---|---|
| Compounding ratio (part by weight) | 6 | 7 | 8 |
| (B2) Elastomer | | | |
| Kind | B2-1 | B2-1 | B2-1 |
| Compounding ratio (part by weight) | 22 | 21 | 21 |
| (C) Boehmite | | | |
| Kind | C-1 | C-1 | C-1 |
| Compounding ratio (part by weight) | 10 | 12 | 12 |
| (D) Aromatic carboxylic acid | | | |
| Kind | D-1 | D-1 | D-1 |
| Compounding ratio (part by weight) | 1.0 | 0.5 | 1.0 |
| (E) Other | | | |
| Kind | — | — | — |
| Compounding ratio (part by weight) | — | — | — |
| (F) Propylene block copolymer | | | |
| Kind | F-1 | F-1 | F-1 |
| Compounding ratio (part by weight) | 68 | 67 | 67 |
| Composition | | | |
| (Based on components (A) + (B) + (C)) | | | |
| Component (A) (wt %) | 59 | 58 | 58 |
| Component (B) (wt %) | 31 | 30 | 30 |
| Component (C) (wt %) | 10 | 12 | 12 |
| Component (E) (wt %) | — | — | — |
| Component (B1) (wt %) | 9 | 9 | 9 |
| Component (B2) (wt %) | 22 | 21 | 21 |
| Composition | | | |
| (Based on components (A) + (B)) | | | |
| Component (B) (wt %) | 39 | 38 | 38 |
| Property | | | |
| Flexural modulus (MPa) | 2,030 | 1,930 | 2,160 |
| IZOD impact strength (kJ/m²) | 25 | 29 | 19 |
| MFR (g/10 minutes) | 33 | 23 | 33 |

TABLE 3

| Compounding ratio | Comparative Example | | | |
|---|---|---|---|---|
| (part by weight) | 1 | 2 | 3 | 4 |
| (B2) Elastomer | | | | |
| Kind | B2-l | B2-1 | B2-l | B2-l |
| Compounding ratio | 12 | 22 | 12 | 22 |
| (part by weight) | | | | |
| (C) Boehmite | | | | |
| Kind | — | — | — | — |
| Compounding ratio | — | — | — | — |
| (part by weight) | | | | |
| (D) Aromatic carboxylic acid | | | | |
| Kind | — | — | — | — |
| Compounding ratio | — | — | — | — |
| (part by weight) | | | | |
| (E) Other | | | | |
| Kind | E-l | E-l | E-2 | E-2 |
| Compounding ratio | 10 | 10 | 10 | 10 |
| (part by weight) | | | | |
| (F) Propylene block | | | | |
| copolymer | | | | |
| Kind | F-1 | F-1 | F-1 | F-1 |
| Compounding ratio | 78 | 68 | 78 | 68 |
| (part by weight) | | | | |
| Composition | | | | |
| (Based on components | | | | |
| (A) + (B) + (C)) | | | | |
| Component (A) (wt %) | 68 | 59 | 68 | 59 |
| Component (B) (wt %) | 22 | 31 | 22 | 31 |
| Component (C) (wt %) | — | — | — | — |
| Component (E) (wt %) | 10 | 10 | 10 | 10 |
| Component (B1) (wt %) | 10 | 9 | 10 | 9 |
| Component (B2) (wt %) | 12 | 22 | 12 | 21 |
| Composition | | | | |
| (Based on components | | | | |
| (A) + (B)) | | | | |
| Component (B) (wt %) | 24 | 34 | 24 | 34 |
| Property | | | | |
| Flexural modulus (MPa) | 1,640 | 1,300 | 1,700 | 1,480 |
| IZOD impact | 8 | 40 | 5 | 19 |
| strength (kJ/m²) | | | | |
| MFR (g/10 minutes) | 43 | 34 | 24 | 36 |

TABLE 4

| Compounding ratio | Comparative Example | | |
|---|---|---|---|
| (part by weight) | 5 | 6 | 7 |
| (B2) Elastomer | | | |
| Kind | B2-1 | B2-1 | B2-1 |
| Compounding ratio (part by weight) | 21 | 24 | 21 |
| (C) Boehmite | | | |
| Kind | — | — | C-2 |
| Compounding ratio (part by weight) | — | — | 10 |
| (D) Aromatic carboxylic acid | | | |
| Kind | — | — | — |
| Compounding ratio (part by weight) | — | — | — |
| (E) Other | | | |
| Kind | E-2 | — | — |
| Compounding ratio (part by weight) | 12 | — | — |
| (F) Propylene block copolymer | | | |
| Kind | F-1 | F-1 | F-1 |
| Compounding ratio (part by weight) | 67 | 76 | 69 |
| Composition | | | |
| (Based on components (A) + (B) + (C)) | | | |
| Component (A) (wt %) | 58 | 66 | 60 |
| Component (B) (wt %) | 30 | 34 | 30 |
| Component (C) (wt %) | — | — | 10 |
| Component (E) (wt %) | 12 | — | — |
| Component (B1) (wt %) | 9 | 10 | 9 |
| Component (B2) (wt %) | 21 | 24 | 21 |
| Composition | | | |
| (Based on components (A) + (B)) | | | |
| Component (B) (wt %) | 34 | 34 | 33 |
| Property | | | |
| Flexural modulus (MPa) | 1,750 | 740 | 1,282 |
| IZOD impact strength (kJ/m²) | 14 | 38 | 22 |
| MFR (g/10 minutes) | 34 | 34 | 17 |

B2-1: ethylene-octene copolymer elastomer (manufactured by DuPont Dow Elastomers K.K., trade name of ENGAGE 8200)
C1: boehmite (BET specific surface area = 66 m²/g, a-axis length = 2,520 nm, b-axis length = 102 nm, c-axis length = 102 nm, ratio of a-axis length to b-axis length (a-axis length/b-axis length) = 25)
C2: boehmite (BET specific surface area = 126 m²/g, a-axis length = 103 nm, b-axis length = 7 nm, c-axis length = 7 nm, ratio = a-axis length to b-axis length (a-axis length/b-axis length) = 15)
D-1: 2-naphthoic acid (manufactured by Tokyo Chemical Industry Co., Ltd.)
E-1: talc (manufactured by HAYASHI KASEI Co., Ltd., trade name of MWHST)
E2: fibrous magnesium sulfate (manufactured by Ube Material Industries, trade name of MOS-HIGE A)
F-1: propylene block copolymer (MFR = 49 g/10 minutes, propylene homopolymer content = 87% by weight, content of ethylene-propylene random copolymer elastomer (B1-1) = 13% by weight)

It is understood that the molded articles in Examples 1 to 8 are excellent in their balance between rigidity and impact resistance. On the other hand, the molded articles in Comparative Examples 1 to 7, which do not satisfy the requirements regarding boehmite, are insufficient in their balance between rigidity and impact resistance.

### INDUSTRIAL APPLICABILITY

Molded articles excellent in their balance between rigidity and impact resistance can be obtained from the polypropylene resin composition of the present invention.

1. A polypropylene resin composition comprising:
50 to 99% by weight of a resin (I); and
1 to 50% by weight of boehmite (C) having a BET specific surface area of 20 to 80 m²/g, c-length of 30 to 300 nm, and a ratio of a-axis length to b-axis length of 5 or more;
the resin (I) containing:
50 to 75% by weight of a polypropylene resin (A), which contains a propylene homopolymer and/or a propylene-ethylene random copolymer containing 1.0% by weight or less of ethylene units; and
25 to 50% by weight of an elastomer (B);
provided that the total of the resin (I) and boehmite (C) is 100% by weight, and the total of the polypropylene resin (A) and the elastomer (B) is 100% by weight.

2. The polypropylene resin composition according to claim 1, wherein boehmite (C) has a-axis length of 0.3 to 10 μm.

3. A molded article comprising the polypropylene resin composition of claim 1.

4. A molded article comprising the polypropylene resin composition of claim 2.
